(19) United States
(12) Patent Application Publication
(10) Pub. No.: US 2006/0080507 A1
(43) Pub. Date: Apr. 13, 2006

(54) System and method for unit attention handling

(76) Inventors: John F. Tyndall, Austin, TX (US); Steven A. Justiss, Lakeway, TX (US); Linlin Gao, Cedar Park, TX (US)

Correspondence Address: SPRINKLE IP LAW GROUP, 1301 W. 25TH STREET, SUITE 408, AUSTIN, TX, 78705, US

(21) Appl. No.: 10/848,177

(22) Filed: May 18, 2004

(51) Int. Cl. G06F 12/00

(52) U.S. Cl. 711/132

(57) ABSTRACT

Embodiments of the present invention provide a system and method for handling unit attentions. According to one embodiment of the present invention, a copy manager can receive an extended copy command and can issue a unit attention clearing command, such as the test unit ready command, to the source and destination devices listed in the extended copy command. The copy manager can further issue read commands to the source device and write commands to the destination device to copy data from the source device to the destination device according to the extended copy command.

### TECHNICAL FIELD OF THE INVENTION

The present invention relates to the field of data communications. More particularly, embodiments of the present invention relate to mechanisms for handling unit attentions of devices to/from which data is communicated on a network.

### BACKGROUND

Businesses, governmental organizations and other entities are increasingly saving large volumes data necessary for daily operations. In order to provide proper protection of data for business and legal purposes (e.g., to ensure quick recovery of data in the event of a disaster or to comply with document retention requirements), entities often back up data to a physical media, such as magnetic tapes, on a regular basis. Traditional backup systems placed an application server, backup server, source device, destination device and a local area network (“LAN”) in the data path of backup operations. Under these systems, the LANs were becoming overburdened by the amount of data being copied and often the backup window was too short to achieve a complete backup of data. Many entities have now implemented Storage Area Networks (“SAN”) to relieve much of the burden of mass data storage and backup from the LAN, freeing the LAN for more immediate data storage and manipulation operations.

Many SANs utilize a Fibre Channel-to-SCSI architecture in which SCSI storage devices are connected to Fibre Channel-to-SCSI routers. This allows data to be transferred across the SAN with the speed of Fibre Channel while using well defined SCSI commands. The T10/99-143r1, “Working Draft SCSI Extended Copy Command” (the “99-143r1 Draft”) and NCITS T10 SPC-2 (SCSI Primary Commands-2) (“SPC-2”) provide a mechanism for computer backup application to delegate actual data movement to third party devices known as “copy managers” or “data movers”. The copy managers typically reside in devices, on the Fibre Channel SAN, allowing for “serverless”, “third party copy”, or “server free” copy operations to occur.

Serverless backup architectures typically depend on a “third party copy” device implementing a Data Mover or Copy Manager module on the SAN that manages and controls the transfer of disk blocks and meta data from a source device to a destination device without requiring that all the data pass through a backup server. In current systems, the backup server issues a command for data backup, usually the extended copy command, to the third party copy device and then removes itself from the data path. The third party copy device, in turn, forwards the appropriate instructions to the source and destination devices and data is transferred from the source device to the third party copy device to the destination device. In this manner, only the source, destination and third party copy devices are involved in data backup after the extended copy command is issued. A dedicated backup server is no longer needed, thereby freeing up valuable CPU and memory resources and supporting server consolidation.

One shortcoming of prior art third party copy schemes is handling unit attention conditions. Unit attention conditions are conditions sent out by a target device to inform a host device of the target's status. In general, a target will issue a unit attention condition if it undergoes some change in status of which hosts on the network should be aware. For example, a SCSI target may want to inform all hosts communicating with it that it has been rebooted, has gone off-line and has come back on-line or has undergone some other change in status.

Before a read/write operation is sent to a target device, the unit attention conditions for that device must be cleared on behalf of the device issuing the read/write operation. In third party copy systems, the copy manager, rather than the host originally issuing an extended copy command, issues the read/write operations to the target devices (i.e., source and destination devices) of the extended copy command. Therefore, unit attentions must be cleared on behalf of the copy manager. SPC-2 provides a mechanism by which a host issuing an extended copy command can clear unit attentions on behalf of the copy manager through a Verify Device Operation segment descriptor in the extended copy command. The Verify Device Operation segment can specify issuance of “Test Unit Ready” (“tur”) command to clear unit attentions on behalf of the copy manager (via a “tur” bit in the segment descriptor).

Many hosts, however, do not fully utilize SPC-2 or, instead, issue the extended copy command according to the 99-143r1 Draft. The 99-143r1 Draft does not include a mechanism for clearing unit attentions on behalf of a copy manager. Instead, the unit attentions are only cleared on behalf of the host originally issuing the extended copy commands. The target devices of the extended copy command, however, may see the copy manager as a different initiator and deny read/write requests from the copy manager. Furthermore, even devices that support SPC-2 may not clear unit attentions for the copy manager because they are not programmed to utilize the Verify Device Operation segment with the “tur” bit.

The inability to clear unit attentions on behalf of the copy manager leads to inefficiencies in backup and restore operations, particularly restore operations from streaming target devices. As illustrated in FIG. 1, in a backup operation, a host issues an extended copy command typically containing a random access source device and a streaming target device. The copy manager receives the extended copy command and issues a read command to the source device. If a unit attention condition is outstanding, an error will be returned. Assuming a unit attention condition is not outstanding on the source device, the copy manager will receive data from the source device and issue a write command to the streaming destination device. If a unit attention condition is outstanding on the streaming destination device, an error will be returned. In this case the streaming storage device media (e.g., tape device media) has not moved. If an error is returned based on either a unit attention condition at the source or destination device, the host can reissue the extended copy command and the process can be repeated until the backup is performed. The necessity of the host reissuing the extended copy command decreases the efficiency of the backup operation.

For restore operations in which data is restored from a streaming source device to a random access device, the inefficiencies are even more pronounced. As illustrated in FIG. 2, a copy manager, as the result of an extended copy command, issues a read request to the streaming source. If a unit attention is outstanding the copy manager can send an error to the host and the host can reissue the extended copy command. If a unit attention is not outstanding at the streaming source device, the copy manager can read data from the source device, causing the streaming media to move. The copy manager can then issue a write command to the destination device. If no unit attention condition is outstanding at the destination device, the restore operation can be completed. If, however, a unit attention condition is outstanding at the destination device, the copy manager can return an error. In this case, the read operation at the source device will have caused the streaming source device to move from its original position. Therefore, the host cannot simply reissue the extended copy command. In many prior art systems, no error recovery is possible and a systems administrator must manually reset the streaming source device to its original position.

### SUMMARY OF THE INVENTION

Embodiments of the present invention provide a system and method of handling unit attentions that eliminates, or at least substantially reduces, the shortcomings of prior art systems and methods for dealing with unit attentions. More particularly, embodiments of the present invention provide a copy manager that can issue unit attention clearing commands to source and destination devices listed in an extended copy command.

One embodiment of the present invention can include, at a third party copy device, receiving an extended copy command indicating a source device and a destination device, issuing a first unit attention clearing command to the source device, issuing at least one read command to the source device, receiving data from the source device in response to the at least one read command; issuing a second unit attention clearing command to the destination device, and issuing at least one write command to the destination device to write the data received from the source device to the destination device.

Another embodiment of the present invention can include a third party copy device comprising a processor, one or more interfaces, each interface configured to couple the third party copy to a data transport medium, and a computer readable medium (e.g., RAM, ROM, hard disk drive, optical storage medium, Flash memory or other computer readable medium known in the art) containing computer instructions executable by the processor. The computer instructions can be executable to receive an extended copy command from a host device to copy data from the source device to the destination device, issue a first unit attention clearing command to a source device, issue at least one read command to the source device, receive data from the source device in response to the at least one read command, issue a second unit attention clearing command to a destination device and issue at least one write command to the destination device to write the data received from the source device to the destination device.

Embodiments of the present invention provide an advantage over prior art systems and methods for unit attention handling by reducing the number of times an extended copy command must be retried for backup operations because of outstanding unit attentions.

Embodiments of the present invention provide another advantage over prior art systems for unit attention handling by reducing the need to manually reset storage devices and restart restore operations because of outstanding unit attentions at a destination device when the source device has moved.

Embodiments of the present invention provide yet another advantage by increasing the performance of SANs by reducing the number of extended copy commands that must be issued and retried on the SAN.

### BRIEF DESCRIPTION OF THE FIGURES

A more complete understanding of the present invention and the advantages thereof may be acquired by referring to the following description, taken in conjunction with the accompanying drawings in which like reference numbers indicate like features and wherein:

FIG. 1 is a flow chart illustrating one embodiment of a prior art method for backup operations;

FIG. 2 is a flow chart illustrating one embodiment of a prior art method for restore operations;

FIG. 3 is a diagrammatic representation of a system for carrying out an extended copy command, according to one embodiment of the present invention;

FIG. 4 is a diagrammatic representation of the structure of an extended copy command, according to one embodiment of the present invention;

FIG. 5 is a diagrammatic representation of an extended copy command operation according to one embodiment of the present invention;

FIG. 6 is a flow chart of a method of executing an extended copy command according to one embodiment of the present invention;

FIG. 7 is a diagrammatic representation of one embodiment of a storage router according to the present invention; and

FIG. 8 is a diagrammatic representation of one embodiment a system for controlling data flow at a router.

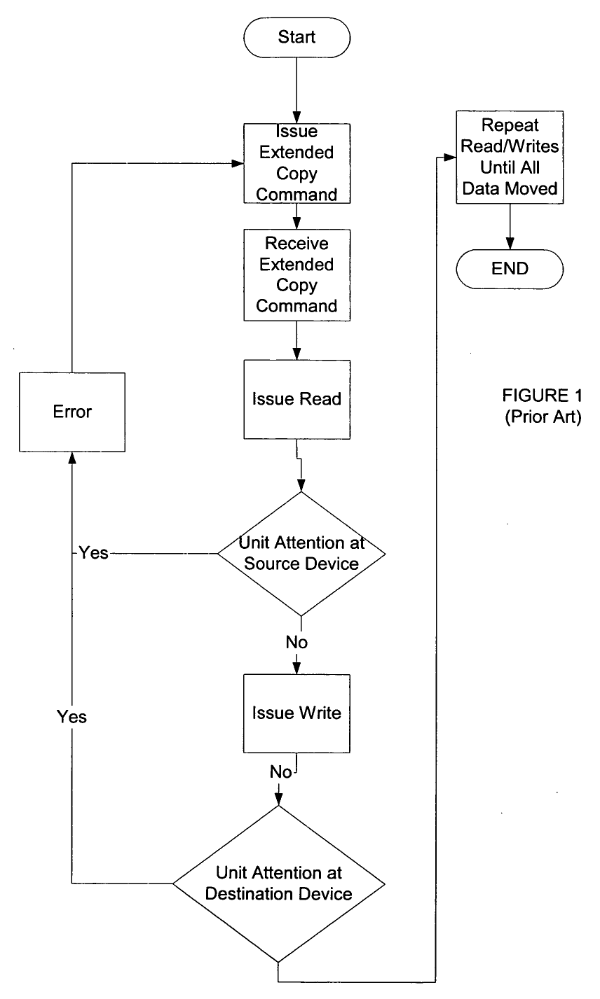

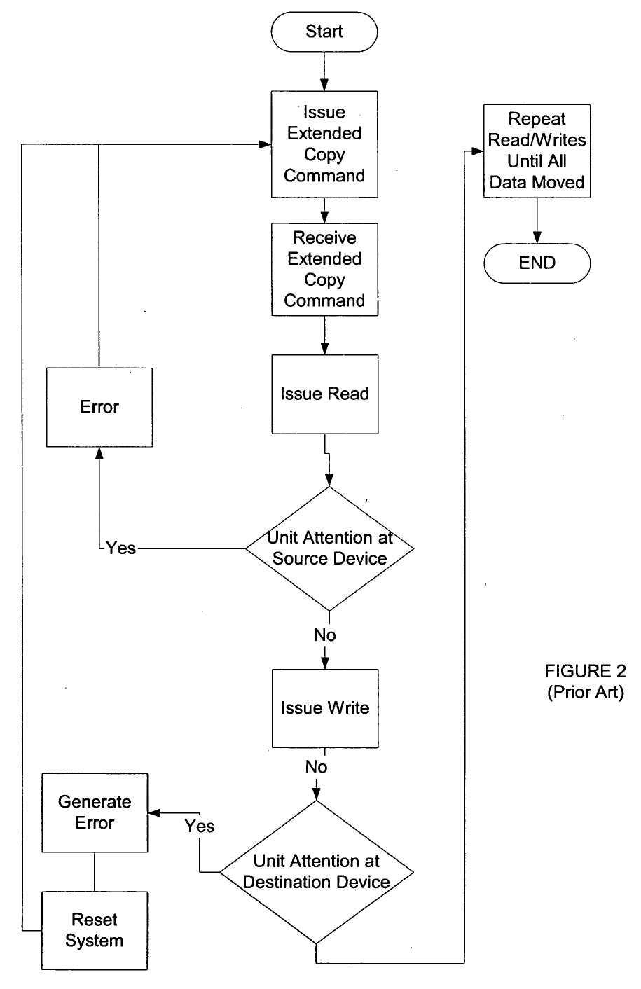

### DETAILED DESCRIPTION

Preferred embodiments of the invention are illustrated in the FIGURES, like numerals being used to refer to like and corresponding parts of the various drawings.

Embodiments of the present invention provide a system and method for handling unit attentions during execution of an extended copy command. According to one embodiment of the present invention, a copy manager can receive an extended copy command issued by a host. The copy manager can determine a source device and a destination device from the extended copy command and can send a command, such as a test unit ready (“tur”) command, to the source and destination devices to clear unit attentions. Because the copy manager issues the “tur” commands (or other unit attention clearing command)to the source and destination device, the source and destination devices will clear the unit attentions for the copy manager so that the copy manager can issue read/write commands to source and destination devices.

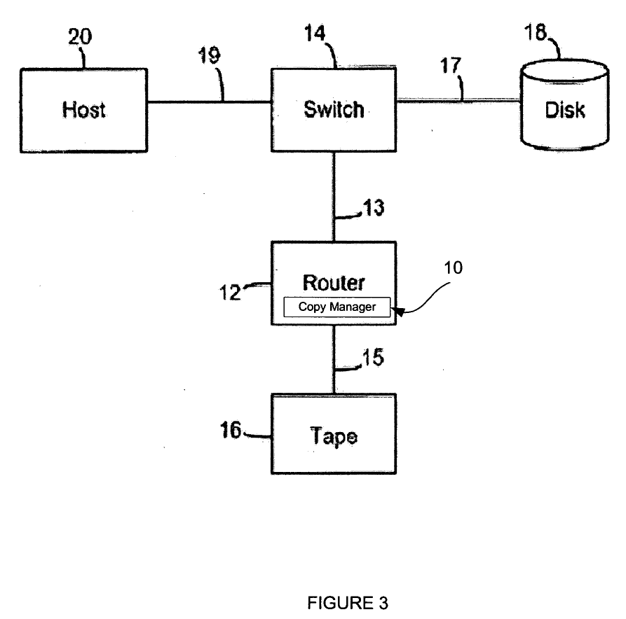

FIG. 3 is a diagrammatic representation of a system for carrying out an extended copy command according to one embodiment of the present invention. In this embodiment, a copy manager 10 capable of executing an extended copy command can be located at a SAN device 12 such as a storage router. For the sake of example, storage router 12 can be a Fibre Channel-to-SCSI router. It should be noted, however, that copy manager 10 can be located at any device capable of receiving the extended copy command and is not limited to being implemented at routers. Moreover, it should be understood that the copy manager 10 can be implemented in other storage routers including, but not limited to: Fibre Channel to Fibre Channel routers; SCSI to SCSI routers; iSCSI to iSCSI routers; Fibre Channel to iSCSI routers; iSCSI to Fibre Channel routers; iSCSI to SCSI routers; SCSI to iSCSI routers; Fibre Channel to Infiniband routers; Infiniband to Fibre Channel routers; iSCSI to advanced technology attachment (“ATA”) routers; ATA to iSCSI routers; iSCSI to Serial ATA (“SATA”) routers; Serial ATA to iSCSI routers; Fibre Channel to Serial Attached SCSI routers; Serial Attached SCSI to Fibre Channel routers; iSCSI to Serial Attached SCSI routers; Serial Attached SCSI to iSCSI routers; Fibre Channel to ATA routers; ATA to Fibre Channel routers; Fibre Channel to SATA routers; SATA to Fibre Channel routers; Fibre Channel to Serial SCSI Architecture routers; Serial SCSI Architecture to Fibre Channel routers; Infiniband to Serial Attached SCSI routers; Serial Attached SCSI to Infiniband routers and other routers supporting protocols that use the extended copy command.

In the embodiment of FIG. 3, router 12 is coupled to a switch 14 by a Fibre Channel interconnect 13. Router 12 is coupled to a first storage device 16 (e.g., a tape drive 16) by a SCSI interconnect 15. Switch 14 is coupled to a second storage device 18 (e.g., hard disk drive 18 or other storage device) by Fibre Channel interconnect 17 and to host 20 by Fibre Channel interconnect 19. It should be noted that, although the embodiment described in detail herein uses a router coupled to tape and disk drives by SCSI and Fibre Channel interconnects, alternative embodiments may use SAN attached appliances other than routers, and they may use other types of interconnects, including SCSI, iSCSI, InfiniBand, ATA, SATA, serial attached SCSI or any other interconnect that allows transport of extended copy commands. Moreover, copy manager 10 can be located at other third party copy devices, such as servers, switches, stand-alone third party copy devices or other network device and can transfer data between various storage devices including, but not limited to, optical drives, tape drives, hard drives, redundant arrays of independent disks (“RAID”) devices and other storage devices known in the art.

Host 20 is capable of accessing the other components of the network via the corresponding Fibre Channel interconnects. Particularly, host 20 is capable of accessing router 12 to delegate to it the management of copy tasks involving other network components, such as tape drive 16 and hard disk drive 18. This is accomplished through the use of extended copy commands issued by host 20 to router 12. Router 12 executes these extended copy commands, reading data from one of the network devices and writing (copying) the data to another one of the components.

The use of extended copy commands allows host 20 to use its own processing power on tasks other than the mere movement of data between network components. For example, it is possible for host 20 to back up hard disk drive 18 to tape drive 16 (a potentially lengthy process) by issuing one or more corresponding extended copy commands to router 12. Router 12 can then copy the backup data from the hard disk drive to the tape drive without the intervention of host 20. Similarly, host 20 can issue one or more extended copy commands to restore data from the tape drive 16 to the hard disk drive 18.

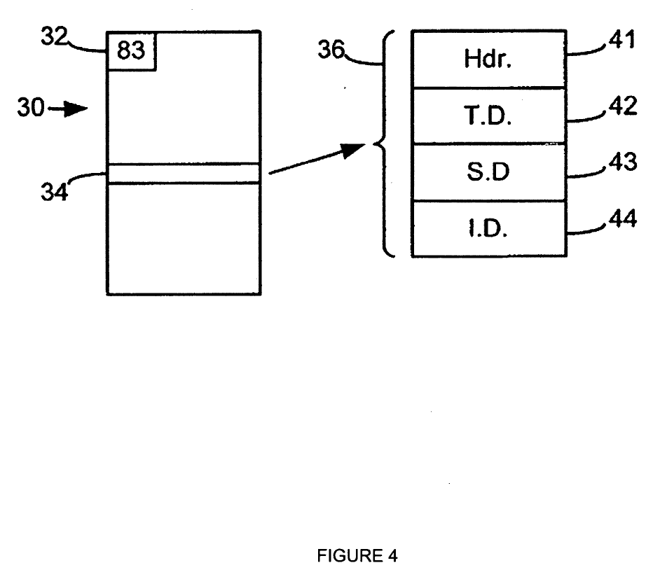

Referring to FIG. 4, a diagrammatic representation of an extended copy command is shown. As shown in the example of FIG. 4, extended copy command 30 has an opcode 32. In this instance, the opcode is a hexadecimal “83”. The command format includes a field 34 which is a count of the size of a list 36 in the data. List 36 has a header 41, a set of target descriptors 42, a set of segment descriptors 43 and in-line data 44.

The target descriptors 42 describe the target devices which will be involved in the extended copy task. The target devices typically include the source device (i.e., the device from which data will be read) and the destination device (i.e., the device to which the data will be written). The destination target device is typically a tape library, but may be another storage device, such as a tape drive, optical library or other device known in the art. The source target device is typically a hard disk drive, but may also be another storage device, such as a hard tape drive, optical library or other device known in the art. The host is typically a Solaris box, a Windows 2000 server, or other device capable of issuing an extended copy command. The source, destination and host devices may, however, be any of a number of different devices. The router or other box in which the present invention is implemented may also vary from one embodiment to another. These devices may have different characteristics, such as the maximum amount of memory which is (or may be) available for transferring data using extended copy commands.

The segment descriptors 43 describe the types of operations that will be performed, as well as the amount of data that will be transferred. For example, a segment descriptor may indicate that block data will be read from a hard disk drive and written to a tape drive (both of which are referenced by the target descriptors). The segment descriptors may describe backup operations, restore operations, block-to-block operations, or other data storage operations. A preferred embodiment is an SPC-2 implementation which supports 8448 segment descriptors or a 99-143r1 Draft implementation. Each of the segment descriptors can move up to 32 MB of data. Thus, a very large amount of data may potentially be moved through a single extended copy command.

Inline data 44 (which may also be referred to as metadata) may or may not be present. Inline data 44 is provided by the host application to describe the operations that will be done. This information may later be used, for example, to enable the backed up data to be restored from the tape to the disk. It should be noted that the SPC-2 standard also allows the use of embedded data segment descriptors to serve the same purpose as inline data segment descriptors.

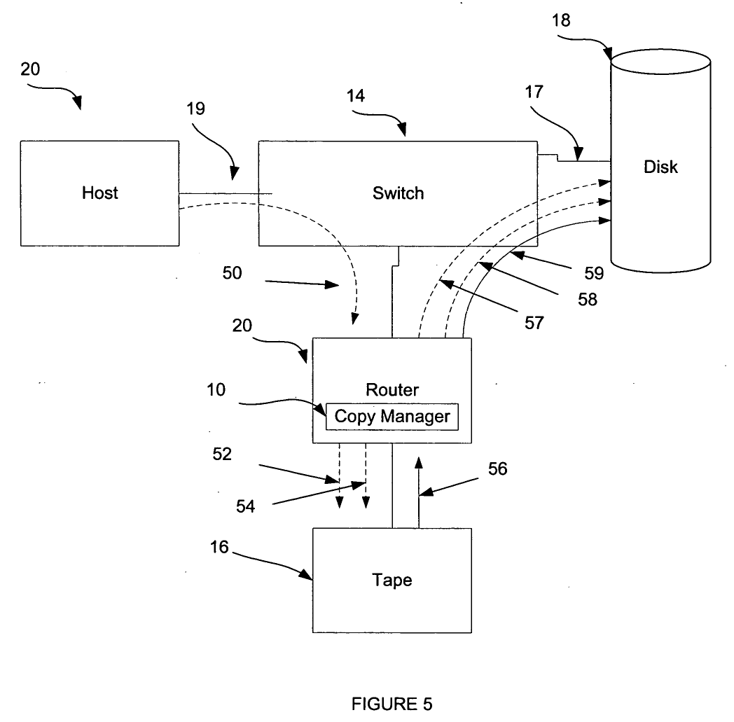

FIG. 5 is a diagrammatic representation of the flow of an extended copy command and corresponding data flow according to one embodiment of the present invention. FIG. 5 includes the example network structure shown in FIG. 3, and also includes lines depicting the flow of commands and data through the system during a backup operation that is performed using extended copy commands. Data flow 50 represents the issuance of an extended copy command from the host. In this example, the extended copy command instructs the router to transfer from tape drive 16 to hard disk drive 18. When the router receives the extended copy command the router can determine the source and destination device from the target descriptors. In addition, the copy manager can construct a “tur” command and send the “tur” command to tape drive 16 to clear one or more unit attentions at tape drive 16 (represented by dataflow 52). The copy manager can then send read commands (represented by data flow 54) to tape drive 16 and begin receiving data from the tape drive. The copy manager can receive data in response to the read commands (represented by line 56). The copy manager can also construct a “tur” command and send it to hard drive 18 (represented by data flow 57) to clear unit attentions at the hard drive 18 on behalf of the copy manager. The copy manager can further construct write commands and issue the write commands to hard drive 18 (represented by line 58) to write data received from tape drive 16 to hard drive 18 (represented by dataflow 59). Because the copy manager issues a unit attention clearing command to the destination device, the copy manager reduces the possibility that the destination device will not process the write commands after data has been read from the source device. For streaming source devices, such as tape drives, this can reduce the need to manually reset the source device and reissue the extended copy command.

According to one embodiment of the present invention, when the extended copy command is executed, the copy manager identifies the target-devices and goes through the segment descriptors sequentially. For each of the segment descriptors, the copy manager builds corresponding read commands to be issued to the source device and write commands to be issued to the destination device. When these read and write commands are issued to the respective devices, they serve to transfer data from the source device to the destination device. Data may not be written to the destination device at the same rate at which it is read from the source device. For example, data may be read from a disk in chunks of 256 kB and then be written to a tape in chunks of 64 kB. Internal buffers (e.g., 16 kB buffers) can be used to buffer data until the copy manager is ready to send data to the destination device.

By issuing unit attention clearing commands, such as the “tur” command, to the source and destination device, the copy manager can ensure that unit attentions are cleared on behalf of the copy manager. Because the source and destination device see the router at which the copy manager is located as the host (i.e., the initiator of the read/write commands), the source and destination devices will clear unit attentions and process read/write or other commands received from the router.

In the example of FIG. 5, a restore operation is illustrated. In the case of a back up operation, the router will receive the extended copy command from the host, issue a unit attention clearing command (e.g., a “tur” command) to the source device (e.g., hard drive 18), issue read commands to the hard drive, issue a unit attention clearing command to the destination device (e.g., tape drive 16) and issue write commands to tape drive 16 to write data received from hard drive 18 to tape drive 16.

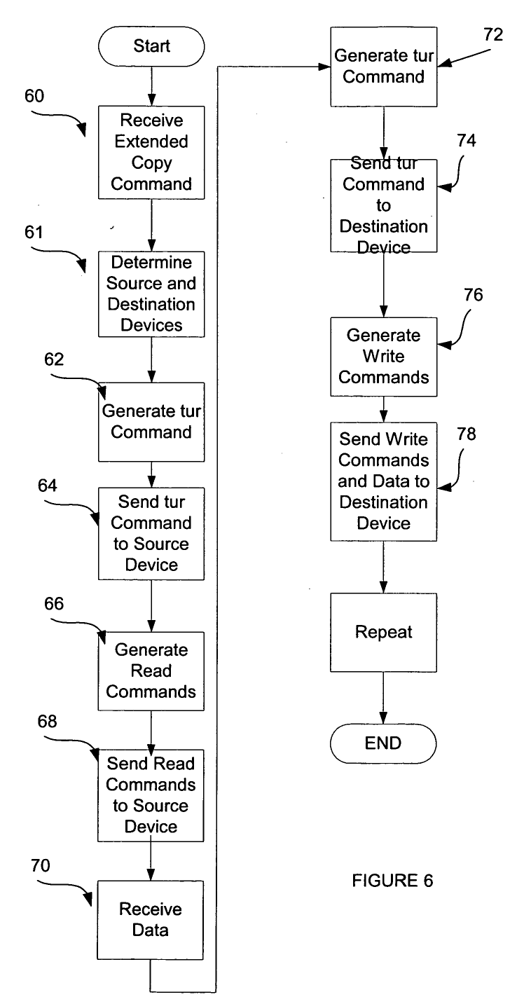

FIG. 6 is a diagrammatic representation of one embodiment of method for handling unit attentions. The method of FIG. 6 can be implemented, according to one embodiment of the present invention, as software instructions stored on a computer readable medium. The software instructions can be, for example, part of a copy manager or data mover program implemented in a storage router or other third party device. Exemplary storage routers in which embodiments of the present invention can be implemented as software programming include the Crossroads 10000, Crossroads 6240 and Crossroads 6000 storage routers manufactured by Crossroads Systems, Inc. of Austin, Tex.

At step 60, the copy manager can receive an extended copy command and can determine the source and destination devices for the extended copy command (step 61). The copy manager, at step 62, can construct a unit attention clearing command, such as a “tur” command, and, at step 64, can send the unit attention clearing command to the source device. At step 66, the copy manager can construct read commands and, at step 68, can send the commands to the destination device. The copy manager can receive and buffer data at step 70. The copy manager, at step 72, can construct a second unit attention clearing command and, at step 74, send it to the destination device. At step 76, the copy manager can construct write commands and, at step 78, send the write commands and data received from the source device to the destination device. Steps 60-78 can be arbitrarily repeated for each extended copy command processed by the copy manager.

In the example of FIG. 6, the copy manager issues a unit attention clearing command to the source device, issues read commands to the source device, issues a unit attention clearing command to the destination device and issues write commands to the destination device. It should be noted, however, that these steps can be performed in other orders. For example, the copy manager can issue both the unit attention clearing commands and then the read commands and the write commands. Moreover, the process of FIG. 6 can be repeated for each extended copy command received, including concurrent extended copy commands. According to one embodiment of the present invention concurrent extended copy commands can be controlled as described in U.S. Pat. No. 6,704,836, entitled “Method for Dynamic Control of Concurrent Extended Copy Tasks” by Griswold, Jr., et al., issued Mar. 9, 2004, which is hereby fully incorporated by reference herein.

It should be noted that, according to one embodiment of the present invention, a copy manager can optionally perform the process of FIG. 6 based on a user setting. For example, a user can select a “unit attention override” setting through a user interface. The user can be given the choice of having unit attentions presented or having the copy manager issue “tur” commands to clear the unit attentions.

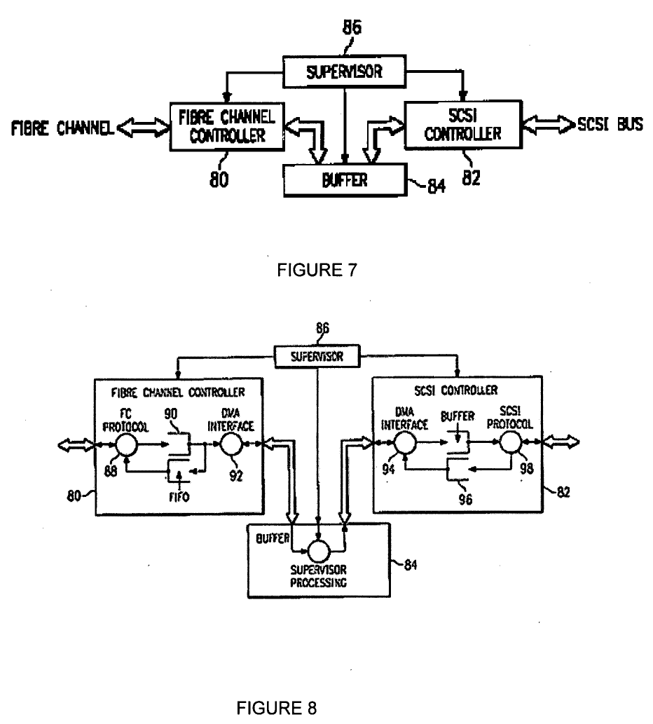

FIG. 7 is a diagrammatic representation of one embodiment of storage router in which a copy manager according to the present invention can be implemented. The storage router can comprise a first transport medium controller 80 that interfaces with a first transport medium and a second transport medium controller that interfaces with a second transport medium 82. In one embodiment of the present invention, the first transport medium can be a Fibre Channel transport medium, the second transport medium a SCSI bus, controller 80 a Fibre Channel controller and controller 82 a SCSI controller. In other embodiments of the present invention the first and second transport media (and respective controllers) can be: Fibre Channel and Fibre Channel; SCSI and SCSI; iSCSI and iSCSI; Fibre Channel and iSCSI; iSCSI and Fibre Channel; iSCSI and SCSI; SCSI and iSCSI; Fibre Channel and Infiniband; Infiniband and Fibre Channel; iSCSI and ATA; ATA and iSCSI; iSCSI and SATA; Serial ATA and iSCSI; Fibre Channel and Serial Attached SCSI; Serial Attached SCSI and Fibre Channel; iSCSI and Serial Attached SCSI; Serial Attached SCSI and iSCSI; Fibre Channel and ATA; ATA and Fibre Channel; Fibre Channel and SATA; SATA and Fibre Channel; Fibre Channel and Serial SCSI Architecture; Serial SCSI Architecture and Fibre Channel; Infiniband and Serial Attached SCSI; Serial Attached SCSI and Infiniband. Moreover, the transport media can operate according to other protocols.

A buffer 84 provides memory work space and is connected to both controller 80 and to controller 82. A supervisor unit 86 is connected to controller 80, controller 82 and buffer 84. Supervisor unit 86 comprises a microprocessor for controlling operation of the storage router, handling mapping and security access and executing the third party copy command as, for example, described in FIG. 6.

FIG. 8 is a block diagram of one embodiment of data flow within the storage router of FIG. 7. As shown, data from the first transport medium (e.g., the Fibre Channel transport medium) is processed by a protocol unit 88 (e.g., a Fibre Channel protocol unit) and placed in a FIFO queue 90. A direct memory access (DMA) interface 92 then takes data out of FIFO queue 90 and places it in buffer 84.

Supervisor unit 86 processes the data in buffer 84 as represented by supervisor processing 93. This processing can include mapping between the first transport medium and the second transport medium, applying access controls and routing functions. For example, supervisor unit 86 can map between Fibre Channel and SCSI, Fibre Channel and Fibre Channel, Fibre Channel and iSCSI or other protocols. A DMA interface 94 then pulls data from buffer 84 and places it into a buffer 96. A second protocol unit 98 pulls data from buffer 96 and communicates the data on the second transport medium (e.g., the SCSI bus). Data flow in the reverse direction, from the second transport medium to the first transport medium, is accomplished in a reverse manner.

In the example of FIGS. 7 and 8, the storage router can be a Fibre Channel to SCSI storage router that can act as a bridge device that connects a Fibre Channel link directly to a SCSI bus and enables the exchange of SCSI command set information between application clients on SCSI bus devices and the Fibre Channel links. Further, the storage router applies access controls such that virtual local storage can be established in remote SCSI storage devices for workstations on the Fibre Channel link. In one embodiment, the storage router provides a connection for Fibre Channel links running the SCSI Fibre Channel Protocol (FCP) to legacy SCSI devices attached to a SCSI bus. The Fibre Channel topology is typically an Arbitrated Loop (FC_AL).

In part, the storage router enables a migration path to Fibre Channel based, serial SCSI networks by providing connectivity for legacy SCSI bus devices. The storage router can be attached to a Fibre Channel Arbitrated Loop and a SCSI bus to support a number of SCSI devices. Using configuration settings, the storage router can make the SCSI bus devices available on the Fibre Channel network as FCP logical units. Once the configuration is defined, operation of the storage router is transparent to application clients. In this manner, the storage router can form an integral part of the migration to new Fibre Channel based networks while providing a means to continue using legacy SCSI devices.

In one implementation (not shown), the storage router can be a rack mount or free standing device with an internal power supply. The storage router can have a Fibre Channel and SCSI port, and a standard, detachable power cord can be used, the FC connector can be an optical Small Form Factor (“SFF”) connector, and the SCSI connector can be a VHDCI type. Additional modular jacks can be provided for a serial port and a 802.3 10BaseT port, i.e. twisted pair Ethernet, for management access. The SCSI port of the storage router an support SCSI direct and sequential access target devices and can support SCSI initiators, as well. The Fibre Channel port can interface to SCSI-3 FCP enabled devices and initiators or other Fibre Channel devices.

To accomplish its functionality, one implementation of the storage router uses: a Fibre Channel interface based on the Agilent XL2 2 Gb/s Fibre Channel controller and an optical SFF transceiver; a PMCS RM7000A processor, incorporating independent data and program memory spaces, and associated logic required to implement a stand alone processing system; and a serial port for debug and system configuration. Further, this implementation includes a SCSI interface supporting Ultra-2 based on the SYMBIOS 53C8xx series SCSI controllers, and an operating system based upon the WIND RIVERS SYSTEMS VXWORKS kernel. In addition, the storage router includes software as required to control functions of the various elements, execute the extended copy command, generate commands and provide appropriate translations between the FC and SCSI protocols.

Although the present invention has been described in detail herein with reference to the illustrated embodiments, it should be understood that the description is by way of example only and is not to be construed in a limiting sense. It is to be further understood, therefore, that numerous changes in the details of the embodiment of this invention and additional embodiments of this invention will be apparent, and may be made by, persons of ordinary skill in the art having reference to this description. It is contemplated that all such changes and additional embodiments are within scope of the invention as claimed below.

What is claimed is:

1. A method for handling unit attentions comprising: at a third party copy device:
receiving an extended copy command indicating a source device and a destination device;
issuing a first unit attention clearing command to the source device;
issuing at least one read command to the source device;
receiving data from the source device in response to the at least one read command;
issuing a second unit attention clearing command to the destination device; and
issuing at least one write command to the destination device to write the data received from the source device to the destination device.

2. The method of claim 1, further comprising:
at a host, constructing the extended copy command, wherein the extended copy command does not include a Verify Device Operation segment with test unit ready bit set.

3. The method of claim 1, wherein the first unit attention clearing command and the second unit attention clearing command are test unit ready commands.

4. The method of claim 3, wherein the source device is a tape drive and the destination device is a hard disk drive.

5. The method of claim 3, wherein the source device is a hard disk drive and the destination device is a tape drive.

6. The method of claim 3, wherein each of the source device and destination device is a hard disk drive.

7. The method of claim 3, wherein each of the source device and destination device is a tape drive.

8. The method of claim 1, wherein the third party copy device is a router.

9. The method of claim 1, wherein the third party copy device is a SAN attached appliance.

10. The method of claim 1, wherein the source device is a streaming device.

11. The method of claim 1, wherein the destination device is a streaming device.

12. A third party copy device comprising:
a processor;
one or more interfaces, each interface configured to couple the third party copy to a data transport medium;
a computer readable medium containing computer instructions executable by the processor, wherein the computer executable instructions comprise instructions to:
receive an extended copy command from a host device to copy data from the source device to the destination device;
issue a first unit attention clearing command to a source device;
issue at least one read command to the source device;
receive data from the source device in response to the at least one read command;
issue a second unit attention clearing command to a destination device; and
issue at least one write command to the destination device to write the data received from the source device to the destination device.

13. The third party copy device of claim 12, wherein the extended copy command does not contain a Verify Device Operation segment with a test unit ready bit set.

14. The third party copy device of claim 12, wherein the third party copy device is configured to communicate with the host device according to a first transport protocol and the source device according to a second transport protocol.

15. The third party copy device of claim 12, wherein the third party copy device is configured to interface with the host device according to a first transport protocol and the destination device according to a second transport protocol.

16. The third party copy device of claim 12, wherein the first unit attention clearing command and the second unit attention clearing command are test unit ready commands.

17. The third party copy device of claim 12, wherein the source device is a tape drive and the destination device is a hard disk drive.

18. The third party copy device of claim 12, wherein the source device is a hard disk drive and the destination device is a tape drive.

19. The third party copy device of claim 12, wherein each of the source device and destination device is a hard disk drive.

20. The third party copy device of claim 12, wherein each of the source device and the destination device is a tape drive.

21. The third party copy device of claim 12, wherein the third party copy device is a router.

22. The third party copy device of claim 12, wherein the third party copy device is a SAN attached appliance.

23. The third party copy device of claim 12, wherein the source device is a streaming device.

24. The third party copy device of claim 12, wherein the destination device is a streaming device.

25. A computer program device comprising a computer readable medium storing a set of computer instructions, wherein the set of computer instructions comprise instructions executable to:
receive an extended copy command from a host device to copy data from a source device to the destination device;
issue a first unit attention clearing command to a source device;
issue at least one read command to the source device;
receive data from the source device in response to the at least one read command;
issue a second unit attention clearing command to a destination device; and
issue at least one write command to the destination device to write the data received from the source device to the destination device.

26. The computer program device of claim 25, wherein the extended copy command does not contain a Verify Device Operation segment with a test unit ready bit set.

27. The computer program device of claim 25, wherein the first unit attention clearing command and the second unit attention clearing command are test unit ready commands.

28. The computer program device of claim 25, wherein the source device is a tape drive and the destination device is a hard disk drive.

29. The computer program device of claim 25, wherein the source device is a hard disk drive and the destination device is a tape drive.

30. The computer program device of claim 25, wherein each of the source device and the destination device is a hard disk drive.

31. The computer program device of claim 25, wherein each of the source device and destination device is a tape drive.

32. The third party copy device of claim 10, wherein the source device is a streaming device.

33. The third party copy device of claim 10, wherein the destination device is a streaming device.
